(19) United States
(12) Patent Application Publication
(10) Pub. No.: US 2006/0040781 A1
(43) Pub. Date: Feb. 23, 2006

(54) Differential drive system

(75) Inventor: John W. Cross, Collegeville, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: ASI Technologies, Inc.

(21) Appl. No.: 11/204,538

(22) Filed: Aug. 16, 2005

Related U.S. Application Data
(60) Provisional application No. 60/602,049, filed on Aug. 17, 2004.

(51) Int. Cl. F16H 48/06

(52) U.S. Cl. 475/248

(57) ABSTRACT

A differential drive system includes a housing having a pair of opposed apertures aligned along a longitudinal axis of the housing. First and second output shafts are positioned in respective apertures and are each at least substantially aligned with the longitudinal axis. First and second spur gears are secured to the first and second output shafts, respectively, positioned proximate respective inboard ends thereof. An output gear is within the housing and has a central bore substantially aligned with the longitudinal axis. First and second planetary spur gears are mounted on the output gear to rotate therewith and to rotate with respect to the output gear about respective planetary axes offset from and substantially parallel to the longitudinal axis of the housing. The first and second planetary spur gears are respectively drivingly engaged with the first and second spur gears to transfer torque to the first and second output shafts.

### CROSS-REFERENCE TO RELATED APPLICATIONS

This application claims the benefit of U.S. Provisional Patent Application No. 60/602,049, entitled “Transaxle Drive System”, filed Aug. 17, 2004, which is incorporated herein by reference.

### BACKGROUND OF THE INVENTION

The present invention relates generally to differential drive systems and, more particularly, to a differential drive system for small electric vehicles.

In conventional differential drive system designs, bevel gears are typically used in differential gear systems thereof. A housing of the differential drive system must be at least large enough to accommodate such a bevel gear system within. Because of the inherent configuration of such bevel gear differentials, the housing of the differential drive system must be relatively large and heavy. This poses a potential problem in using the differential drive system in smaller vehicles where size and weight concerns are paramount. An additional problem inherent in differential drive systems having bevel gears is that, because needle bearings are typically used for rotatably coupling shafts of the differential drive system with the housing, the shafts typically must be heat treated in order to be of sufficient hardness to be used with needle bearings. The heat treatment of the shafts represents an additional step in the production of the differential drive system, requiring additional time and expense to accomplish. Another problem inherent in such differential drive systems is that the use of needle bearings within the differential drive system typically complicates the assembly of the differential drive system because the needle bearings are required to be press fit into the housing supporting the needle bearings, adding further time and expense to the assembly of the differential drive system.

It is desirable to have a differential drive system that overcomes these problems. Specifically, it is desirable to have a differential drive system that has a reduced size and weight from that of comparably performing conventional bevel gear differential drive systems. Additionally, it is desirable to have a differential drive system that can be manufactured for a cost that is reduced from that of the conventional bevel gear differential drive systems.

### BRIEF SUMMARY OF THE INVENTION

Briefly stated, the present invention is a differential drive system comprising a housing having a cavity and a pair of opposed apertures in communication with the cavity. Each of the apertures is aligned along a longitudinal axis of the housing. A first output shaft is positioned in one of the apertures and is at least substantially aligned with the longitudinal axis of the housing. The first output shaft has an inboard end within the cavity. The first output shaft is mounted on at least one ball bearing assembly in order to rotate with respect to the housing. A second output shaft is positioned in the other of the apertures and is at least substantially aligned with the longitudinal axis of the housing. The second output shaft has an inboard end within the cavity. The second output shaft is mounted on at least one ball bearing assembly in order to rotate with respect to the housing. A first spur gear is secured to the first output shaft proximate the inboard end of the first output shaft. A second spur gear is secured to the second output shaft proximate the inboard end of the second output shaft. An output gear is positioned within the cavity and has a central bore substantially aligned with the longitudinal axis of the housing. First and second planetary spur gears are mounted on the output gear to rotate therewith. The first and second planetary spur gears each are further rotatable with respect to the output gear about a respective planetary axis offset from and substantially parallel to the longitudinal axis of the housing. The first and second planetary spur gears are respectively drivingly engaged with the first and second spur gears to transfer torque to the first and second output shafts.

### BRIEF DESCRIPTION OF THE SEVERAL VIEWS OF THE DRAWINGS

The foregoing summary, as well as the following detailed description of a preferred embodiment of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a top perspective view of a preferred embodiment of a differential drive system in accordance with the present invention;

FIG. 2 is a right side elevation view of the differential drive system of FIG. 1;

FIG. 3 is a top plan view of the differential drive system of FIG. 1;

FIG. 4 is a cross sectional view of the differential drive system of FIG. 1, taken along line 4-4 of FIG. 2;

FIG. 5 is an exploded view of the differential drive system of FIG. 1; and

FIG. 6 is a partially cut-away perspective view of an output gear of the differential drive system of FIG. 1.

### DETAILED DESCRIPTION OF THE INVENTION

Certain terminology is used in the following description for convenience only and is not limiting. The words “right,” “left,” “upper,” and “lower” designate directions in the drawings to which reference is made. The terminology includes the words above specifically mentioned, derivatives thereof, and words of similar import.

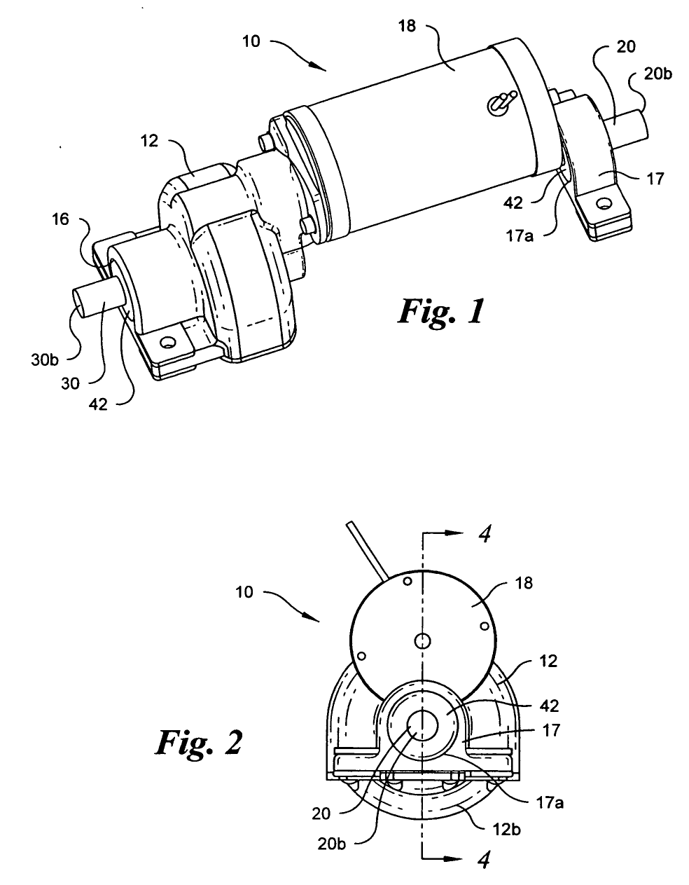

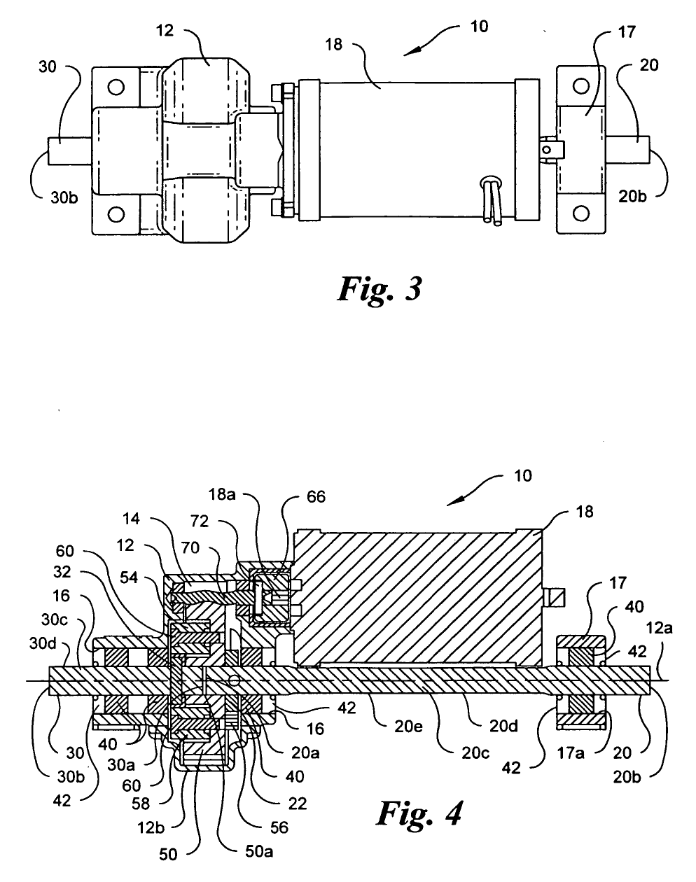

Referring the drawings in detail, wherein like numerals indicate like elements throughout, there is shown in FIGS. 1-6 a differential drive system, indicated generally at 10, in accordance with a preferred embodiment of the present invention. The differential drive system 10 provides substantially the same functionality as a typical differential drive system, such as the gear drive system disclosed in U.S. Pat. No. 6,626,788 B2 (Cross), which is incorporated herein by reference. The differential drive system 10, as disclosed below and shown in FIGS. 1-6, is intended to reduce the weight, size, and cost of manufacture from that of typical differential drive systems, such as conventional bevel gear differential drive systems, for instance.

Referring to FIGS. 1-5, the differential drive system 10 includes a housing 12 having a cavity 14 and a pair of opposed apertures 16 in communication with the cavity 14. The housing 12 has a longitudinal axis 12a along which each of the apertures 16 is preferably aligned. The housing 12 preferably has a cover 12b, which is removable from the rest of the housing 12 in order to access the cavity 14 and the contents thereof, as are described below.

A first output shaft 20 is preferably positioned in one of the apertures 16 and is at least substantially aligned with the longitudinal axis 12a of the housing 12. The first output shaft 20 has an inboard end 20a within the cavity. The first output shaft 20 is mounted on at least one ball bearing assembly 40 in order to rotate with respect to the housing 12. The ball bearing assembly 40 is appropriately sized in order to accommodate the first output shaft 20 therethrough to enable rotation of the first output shaft 20 with respect to the housing 12. Such ball bearing assemblies 40 are well-known in the art and, therefore, require no further explanation or description.

Preferably, the ball bearing assembly 40 is disposed and supported within the aperture 16 of the housing 12. The first output shaft 20 is preferably positioned within the aperture 16 such that the ball bearing assembly 40 is disposed proximate the inboard end 20a of the first output shaft 20.

The differential drive system 10 further includes a shaft support block 17. The shaft support block 17 preferably has a bore 17a therethrough, which is generally aligned along the longitudinal axis 12a of the housing 12. The shaft support block 17 is preferably separated from the housing 12 and functions to support an outboard end 20b of the first output shaft 20. The distance separating the shaft support block 17 from the housing 12 can be varied according to the length of the first output shaft 20 and/or mounting requirements for a particular vehicle (not shown) or other device (not shown) with which the differential drive system 10 of the present invention is used. Preferably, the housing 12 and the shaft support block 17 are die cast aluminum, although it is within the spirit and scope of the present invention that the housing 12 and the shaft support block 17 be made from a different material, provided they are still capable of functioning as described herein.

Another ball bearing assembly 40 is preferably disposed within the bore 17a of the shaft support block 17 to allow the first output shaft 20 to rotate with respect to the shaft support block 17. The ball bearing assembly 40 is similar, if not identical, to the ball bearing assembly 40 discussed above.

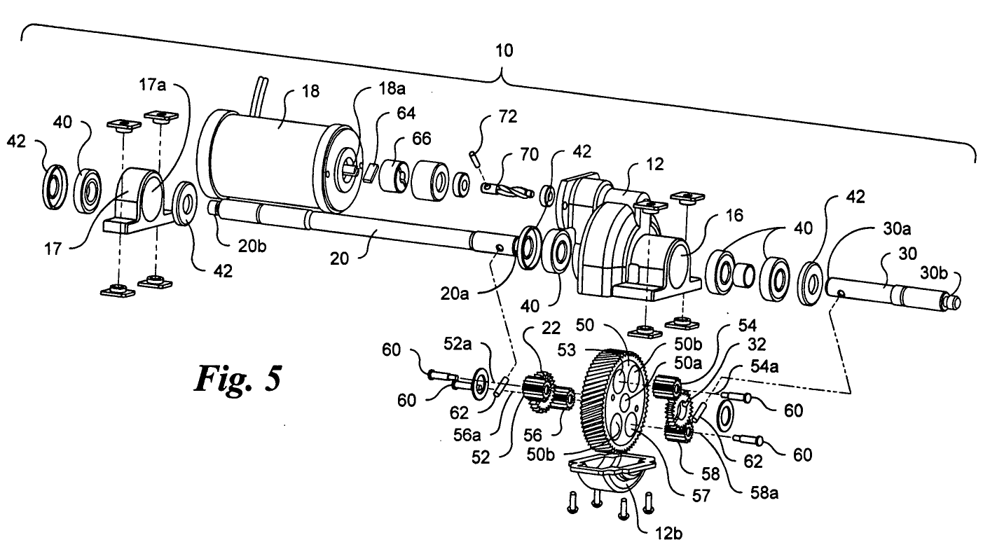

Referring specifically to FIG. 5, preferably, there is no structure protecting the first output shaft 20 such that at least a portion of the first output shaft 20 between the housing 12 and the shaft support block 17 is exposed to atmosphere. Doing so at least aids in reducing the weight of the differential drive system 10. While this is preferred, it is within the spirit and scope of the present invention that the first output shaft 20 be protected by a cover or some other protective structure, if desired.

Referring again to FIGS. 1-5, preferably, a second output shaft 30 is positioned in the other of the apertures 16 and is at least substantially aligned with the longitudinal axis 12a of the housing 12. The second output shaft 30 has an inboard end 30a within the cavity 14 of the housing 12 and an opposite outboard end 30b disposed outside of the housing 12. Preferably, the first and second output shafts 20, 30 are made of steel alloy, although it is within the spirit and scope of the present invention that another material be used, provided the alternate material is capable of functioning as described herein.

Like the first output shaft 20, second output shaft 30 is preferably mounted on at least one ball bearing assembly 40 in order to rotate with respect to the housing 12. The ball bearing assembly 40 is essentially similar to the ball bearing assemblies 40 described above and, therefore, will not be described in detail. The ball bearing assembly 40 is preferably located within the aperture 16 and is appropriately sized to accept the second output shaft 30 therethrough in order to rotate with respect to the housing 12. Preferably, two ball bearing assemblies 40 are located within the aperture 16 of the housing 12 within which the second output shaft 30 is disposed in order to support the second output shaft 30. While this is preferred, it is within the spirit and scope of the present invention that more or less than two ball bearing assemblies 40 are located within the aperture 16 to support the second output shaft 30.

Referring specifically to FIG. 5, seals 42 are preferably used within the apertures 16 and the bore 17a of the shaft support block 17. Preferably, the seals 42 are generally disc-shaped and have a hole through centers thereof to allow the first or second output shaft 20, 30 to pass therethrough when the differential drive system 10 is fully assembled. The seals 42 function to enclose the ball bearing assemblies 40 within their respective apertures 16 and bore 17a, thereby at least inhibiting contaminants, such as dust, dirt, or rocks, for instance, from entering the apertures 16 and bore 17a and impeding the performance of the ball bearing assemblies 40.

Referring now to FIG. 4, the first and second output shafts 20, 30 are preferably in as-wrought condition. That is, an interior 20c, 30c of each of the first and second output shafts 20, 30 is generally the same hardness as an exterior 20d, 30d of each of the first and second output shafts 20, 30. Typically, heat-treated, surface-hardened shafts are required for use in differential drive systems because of hardness requirements associated with the use of needle bearings within the differential drive systems to rotatably couple the shafts to the housings. As-wrought shafts generally do not have sufficient surface hardness for use with needle bearings. However, because ball bearing assemblies 40 are used with the differential drive system 10 of the present invention instead of needle bearings, and because of the lesser surface hardness requirements associated with the ball bearing assemblies 40, there is no need to heat treat the first and second output shafts 20, 30. Eliminating the need to heat treat the first and second output shafts 20, 30 eliminates a step from the manufacture of the differential drive system 10, resulting in reduced time and cost of manufacture. However, it is noted that, while generally not being necessary, it is possible and, therefore, within the spirit and scope of the present invention to use heat-treated first and second output shafts 20, 30 with the differential drive system 10, if desired.

Additionally, the use of ball bearing assemblies 40 instead of needle bearings allows for easier assembly of the differential drive system 10. This is because the ball bearing assemblies 40 need not be pressed into the housing 12 or shaft support block 17, as would be required if needle bearings were to be used. Eliminating the step of pressing the ball bearing assemblies 40 further reduces the time and cost associated with assembly of the differential drive system 10.

Referring now to FIGS. 4 and 5, a first spur gear 22 is preferably positioned proximate the inboard end 20a of the first output shaft 20. A second spur gear 32 is preferably positioned proximate the inboard end 30a of the second output shaft 30. The first and second spur gears 22, 32 are preferably held in place using cross pins 62 to extend through the first and second output shafts 20, 30 and abut the respective first and second spur gears 22, 32 to secure the first and second spur gears 22, 32 to the respective first and second output shafts 20, 30 for rotation therewith. Although this is preferred, it is within the spirit and scope of the present invention that other manners of attaching the first and second spur gears 22, 32 to the first and second output shafts 20, 30 be used, provided the differential drive system 10 is capable of functioning as described herein.

An output gear 50 is positioned within the cavity 12a and has a central bore 50a substantially aligned with the longitudinal axis 12a of the housing 12. Preferably, the inboard ends 20a, 30a of the first and second output shafts 20, 30 are disposed at least partially within the central bore 50a of the output gear 50. By partially disposing the inboard ends 20a, 30a of the first and second output shafts 20, 30 within the central bore 50a of the output gear 50, additional support for the first and second output shafts 20, 30 is provided. As such, only one ball bearing assembly 40 is required within the aperture 16 of the housing 12 to support the inboard end 20a of the first output shaft 20.

First and second planetary spur gears 52, 54 are preferably mounted on the output gear 50 to rotate therewith about the longitudinal axis 12a. The first and second planetary spur gears 52, 54 are each further rotatable with respect to the output gear 50 about a respective planetary axis 52a, 54a offset from and substantially parallel to the longitudinal axis 12a of the housing 12. The first and second planetary spur gears 52, 54 are respectively drivingly engaged with the first and second spur gears 22, 32 to transfer torque to the first and second output shafts 20, 30.

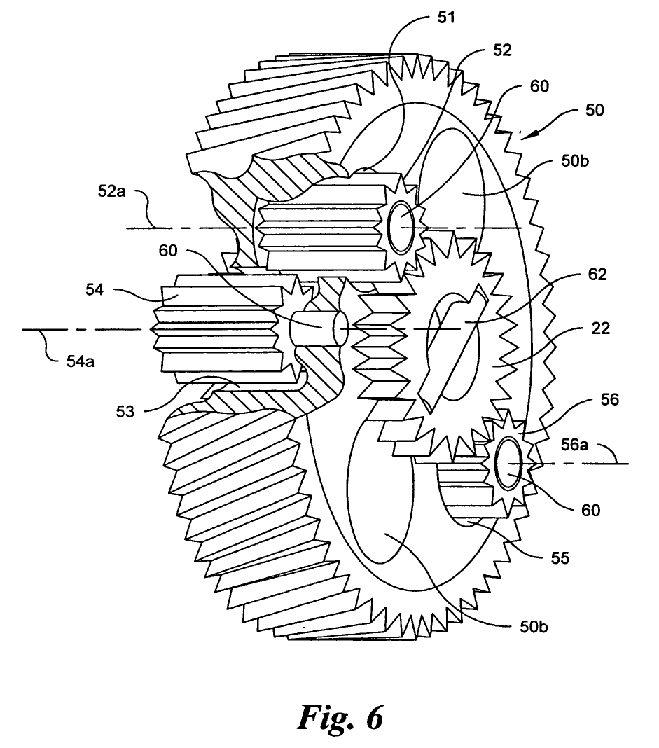

Referring now to FIG. 6, the first planetary spur gear 52 preferably meshes with the second planetary spur gear 54. Preferably, the first and second planetary spur gears 52, 54 are disposed within first and second holes 51, 53, respectively, within the output gear 50 and are rotatable about pins 60 disposed along the first and second planetary axes 52a, 54a, respectively. The first and second holes 51, 53 are positioned such that the first and second holes at least partially overlap within the output gear 50, such that at least a portion of the first hole 51 is in communication with at least a portion of the second hole 53, thereby allowing the first and second planetary spur gears 52, 54 to mesh with each other within the output gear 50.

Referring now to FIGS. 5 and 6, the differential drive system 10 preferably further includes third and fourth planetary spur gears 56, 58 mounted on the output gear 50 to rotate therewith about the longitudinal axis 12a. As with the first and second planetary spur gears 52, 54, the third and fourth planetary spur gears 56, 58 are each further rotatable with respect to the output gear 50 about a respective third and fourth planetary axis 56a, 58a offset from and substantially parallel to the longitudinal axis 12a of the housing 12. The third and fourth planetary spur gears 56, 58 are respectively drivingly engaged with the first and second spur gears 22, 32 to transfer torque to the first and second output shafts 20, 30. While it is preferable to further include the third and fourth planetary spur gears 56, 58 with the differential drive system 10, the differential drive system 10 is capable of functioning as described herein without the third and fourth planetary spur gears 56, 58. Therefore, although preferable to have first, second, third, and fourth planetary spur gears 52, 54, 56, 58, it is within the spirit and scope of the present invention to only have first and second planetary spur gears 52, 54 for use within the differential drive system 10.

Preferably, the planetary axes 52a, 56a of the first and third planetary spur gears 52, 56 are disposed in the output gear 50 diametrically opposite one another, and the planetary axes 54a, 58a of the second and fourth planetary spur gears 54, 58 are disposed in the output gear 50 diametrically opposite one another. Preferably, the output gear 50 further has hollows 50b therethrough in order to reduce the weight of the output gear 50. Preferably, there are two hollows 50b diametrically opposite one another, with one hollow 50b being disposed radially between the first planetary spur gear 52 and the fourth planetary spur gear 58, and the other hollow 50b being disposed between the second planetary spur gear 54 and the third planetary spur gear 56. While it is preferred to have two diametrically opposite hollows 50b, it is within the spirit and scope of the present invention to have more or less than two hollows 50b, provided the output gear 50 is still capable of functioning as described herein.

Preferably, the third planetary spur gear 56 meshes with the fourth planetary spur gear 58. Similarly to the first and second planetary spur gears 52, 54, the third and fourth planetary spur gears 56, 58 are preferably disposed within third and fourth holes 55, 57, respectively, in the output gear 50. The third and fourth holes 55, 57 at least partially overlap within the output gear 50, such that at least a portion of the third hole 55 is in communication with at least a portion of the fourth hole 57, thereby allowing the third and fourth planetary spur gears 56, 58 to mesh with each other within the output gear 50.

Referring again to FIGS. 1-5, the differential drive system 10 further includes a motor 18 drivingly engaged with the output gear 50 for causing rotation of the first and second output shafts 20, 30. Preferably, the motor 18 is electrically powered. Specifically, it is preferred that the motor 18 is powered by a conventional rechargeable battery. Although this is preferred, it is within the spirit and scope of the present invention that the motor 18 be connected to a stationary power source, such as a wall outlet or a generator, for instance, or that the motor 18 be powered by something other than electricity, such as by gasoline or natural gas, for instance.

The motor 18 preferably has an output shaft 18a extending outwardly therefrom. A coupling 66 is rotatably engaged with the output shaft 18a with a key 64. A pinion 70 is then engaged with the coupling 66 using a pin 72. The pinion 70 functions to drive the output gear 50. Driving the output gear 50 in this manner not only functions to transfer torque from the output shaft 18a of the motor 18 to the first and second output shafts 20, 30, it also functions to reduce the rotational speed between the output shaft 18a and the output gear 50.

In use, the differential drive system 10 functions essentially as a typical differential drive system, such as the differential gear drive system disclosed in Cross. However, because spur gears 22, 32, 52, 54, 56, 58 are used instead of bevel gears, as are typically used, the differential drive system 10 can provide higher strength than comparably-sized standard bevel gear-type differentials. Moreover, the use of spur gears 22, 32, 52, 54, 56, 58 allows for the housing 12 to be smaller than that of a comparable bevel gear-type differential. That, in addition to the lack of protection around the first output shaft 20, the hollows 50b in the output gear 50, the use of light-weight material, and other factors, allows the differential drive system 20 to be smaller, lighter weight, and have a lower cost than comparable bevel gear-type differentials.

Also, because ball bearing assemblies 40 are used instead of the typical needle bearings, the first and second output shafts 20, 30 are not required to be heat-treated, thereby eliminating an extra step for manufacturing and assembling the differential drive system 10. The elimination of this step translates to reduced cost and time of assembly of the differential drive system 10. Additionally, because the ball bearing assemblies 40 need not be pressed into the aperture 16 of the housing 12 or the shaft support block 17, as would be required if needle bearings were to be used, a further assembly step is eliminated, resulting in a further reduction in time and cost of assembly.

Lastly, spur gears can typically be produced at less cost than bevel gears. This is because highly specialized machines are required to produce bevel gears, whereas spur gears are the most common type of gearing with the associated lower manufacturing costs involved. Spur gearing is also the most cost-effective type when using powdered metal processes, which are highly preferred for high-quantity production consistent with adequate gear load carrying capacity.

In this way, the differential drive system 10 can have a reduced size and weight from that of comparably performing conventional bevel gear differential drive systems. Additionally, the differential drive system 10 can be manufactured for a cost that is reduced from that of the conventional bevel differential drive systems and in less time.

It will be appreciated by those skilled in the art that changes could be made to the embodiment described above without departing from the broad inventive concepts thereof. It is understood, therefore, that this invention is not limited to the particular embodiment disclosed, but it is intended to cover modifications within the spirit and scope of the present invention as defined by the appended claims.

I claim:

1. A differential drive system, comprising:
a housing having a cavity and a pair of opposed apertures in communication with the cavity, each of the apertures aligned along a longitudinal axis of the housing;
a first output shaft positioned in one of the apertures and being at least substantially aligned with the longitudinal axis of the housing, the first output shaft having an inboard end within the cavity, the first output shaft being mounted on at least one ball bearing assembly in order to rotate with respect to the housing;
a second output shaft positioned in the other of the apertures and being at least substantially aligned with the longitudinal axis of the housing, the second output shaft having an inboard end within the cavity, the second output shaft being mounted on at least one ball bearing assembly in order to rotate with respect to the housing;
a first spur gear secured to the first output shaft proximate the inboard end of the first output shaft;
a second spur gear secured to the second output shaft proximate the inboard end of the second output shaft;
an output gear positioned within the cavity and having a central bore substantially aligned with the longitudinal axis of the housing; and
first and second planetary spur gears mounted on the output gear to rotate therewith, the first and second planetary spur gears each being rotatable with respect to the output gear about a respective planetary axis offset from and substantially parallel to the longitudinal axis of the housing, the first and second planetary spur gears being respectively drivingly engaged with the first and second spur gears to transfer torque to the first and second output shafts.

2. The differential drive system of claim 1, wherein the inboard ends of the first and second output shafts are disposed at least partially within the central bore of the output gear.

3. The differential drive system of claim 1, wherein at least one ball bearing assembly is disposed within each of the apertures of the housing.

4. The differential drive system of claim 1, wherein the first and second output shafts are in as-wrought condition, such that an interior of each of the first and second output shafts is generally the same hardness as an exterior of each of the first and second output shafts.

5. The differential drive system of claim 1, wherein the first planetary spur gear meshes with the second planetary spur gear.

6. The differential drive system of claim 5, wherein the first and second planetary spur gears are disposed within first and second holes, respectively, in the output gear, the first and second holes at least partially overlapping within the output gear, such that at least a portion of the first hole is in communication with at least a portion of the second hole.

7. The differential drive system of claim 1, further comprising third and fourth planetary spur gears mounted on the output gear to rotate therewith, the third and fourth planetary spur gears each being further rotatable with respect to the output gear about a respective planetary axis offset from and substantially parallel to the longitudinal axis of the housing, the third and fourth planetary spur gears being respectively drivingly engaged with the first and second spur gears to transfer torque to the first and second output shafts.

8. The differential drive system of claim 7, wherein the planetary axes of the first and third planetary spur gears are disposed in the output gear diametrically opposite one another and the planetary axes of the second and fourth planetary spur gears are disposed in the output gear diametrically opposite one another.

9. The differential drive system of claim 8, wherein the third planetary spur gear meshes with the fourth planetary spur gear.

10. The differential drive system of claim 9, wherein the third and fourth planetary spur gears are disposed within third and fourth holes, respectively, in the output gear, the third and fourth holes at least partially overlapping within the output gear, such that at least a portion of the third hole is in communication with at least a portion of the fourth hole.

11. The differential drive system of claim 1, further comprising a motor drivingly engaged with the output gear for causing rotation of the first and second output shafts.

12. The differential drive system of claim 11, wherein the motor is electrically powered.

13. The differential drive system of claim 1, further comprising a shaft support block separated from the housing for supporting an outboard end of the first output shaft.

14. The differential drive system of claim 13, further comprising at least one ball bearing assembly disposed within the shaft support block to allow the first output shaft to rotate with respect to the shaft support block.

15. The differential drive system of claim 14, wherein at least a portion of the first output shaft between the housing and the shaft support block is exposed to atmosphere.
